(19) United States
(12) Patent Application Publication
(10) Pub. No.: US 2016/0241991 A1
(43) Pub. Date: Aug. 18, 2016

(54) METHOD FOR NEAR FIELD COMMUNICATION WITH A COMPONENT OF AN ELECTRIC WELDING INSTALLATION, AND COMPONENT OF AN ELECTRIC WELDING INSTALLATION FOR CARRYING OUT THE METHOD

(71) Applicant: Lorch Schweisstechnik GmbH, Auenwald (DE)

(72) Inventor: Josef Goeppert, Kusterdingen (DE)

(21) Appl. No.: 15/017,988

(22) Filed: Feb. 8, 2016

(30) Foreign Application Priority Data
Feb. 13, 2015 (DE) 10 2015 102 145

(51) Int. Cl. H04W 4/00; B23K 9/10; B23K 9/095

(52) U.S. Cl. CPC H04W 4/008; B23K 9/0953; B23K 9/1087; B23K 9/1006; H04W 84/12

(57) ABSTRACT

A method for near field communication with a component of an electric welding installation is provided, wherein data and/or programs are transmitted via an NFC communication channel. In order to render the method easy to operate and to allow for spontaneous communication with the component of the welding installation, the data and/or programs are embedded in a URI or in a MIME format and are transmitted in a standard format of NFC data transmission via the NFC communication channel between the mobile terminal device and the component of the welding installation. The data and/or programs transmitted from the mobile terminal device are extracted by and directly processed by the component of the welding installation without establishing a connection to a web-based resource and without necessarily presenting the URI data content or MIME data content. Furthermore, a component of an electric welding installation is provided for carrying out the method.

This application claims the benefit of German application number 10 2015 102 145.5 of Feb. 13, 2015, which is incorporated herein by reference in its entirety and for all purposes.

### BACKGROUND OF THE INVENTION

The invention relates to a method for near field communication with a component of an electric welding installation, wherein data and/or programs are transmitted via an NFC communication channel.

The invention further relates to a component of an electric welding installation for carrying out the method.

Electric welding installations for electric arc welding comprise various components such as a control component, a power component and a welding torch including a welding electrode. An electric arc is struck between the welding electrode and a workpiece that is to be welded, and a weld seam is produced by the action of said electric arc. The power component provides the required electric welding voltage and the required electric welding current. The control component controls the power component. A further component that may be used is, for example, an operator control component including an input device and a display device. The welding installation may also comprise a wire feeding component, a water cooling component and/or a network component.

The welding installations can store different programs for carrying out different welding processes and/or for welding different workpieces. Users often acquire such welding installations in order to perform very specific welding tasks. It may, however, happen that at a later time the user wishes to undertake further welding tasks that cannot be negotiated with the functions that were first made available to him or her at the time of acquiring the welding installation. It is then possible for the user to extend the functions of the welding installation whereby, for example, he or she is given further operating capabilities and/or has further programs made available to him or her. Functional extension may also consist in enabling an interface of the welding installation, such as an interface of the control component or of the power component, thereby making it possible for the welding installation to connect with automation systems or additional devices. The interface may also be enabled in order, for example, to permit welding parameters that are present when carrying out certain welding tasks to be read out and/or documented.

For extending the functions of the welding installation, there may be used a software program, a data packet including setting values or parameter values, or, for example, an enabling or authorization code, all of which may be acquired by the user from the manufacturer of the welding installation. For example, provision may be made for the user to acquire from the manufacturer of the welding installation a storage medium capable of being read by a component of the welding installation, for example by the control component thereof, said storage medium having extension data stored thereon. Once the extension data has been read into the component of the welding installation, the desired functional extension can be performed.

By way of example, an NFC card may be used as the storage medium. The NFC card is a chip card or smart card that permits near field communication. Such NFC cards are per se known to the person skilled in the art. They come with a storage chip having data and/or programs stored thereon and allow the wireless transfer of these data and/or programs via an NFC communication channel from the NFC card to a component of the welding installation. The abbreviation “NFC” stands for “Near Field Communication”. NFC is an international transmission standard for the contactless exchange of data and/or programs through radio technology over distances in the range of only a few centimetres.

NFC cards are routinely sent from the manufacturer of the welding installation to the user via regular mail. This entails the risk of the NFC cards getting lost in the post. Moreover, NFC cards first need to be requested by the user and then there will be a considerable delay in time before the user will have them at his or her disposal. Therefore, NFC cards do not allow for a spontaneous functional extension of a welding installation.

The transmission of data and/or programs to a component of a welding installation may also be realized over a line and a serial interface by connecting to the component an external computer, in particular a personal computer or a laptop computer. However, this requires special configuration of the component of the welding installation and the installation of special software on the computer. The software must be created and maintained for different operating systems. For the only occasional use it will see by the user of the welding installation, such a scheme of data and/or program transfer has only limited suitability due to the large amount of effort with which it is associated.

A complex and expensive solution for communicating with a component of a welding installation can also consist in the component being networked via field bus, Ethernet or WLAN. This, however, will reduce the mobility of the welding installation. For use of the welding installation at, for example, a construction site, such a communication scheme is not suited.

It is an object of the present invention to provide a method of the kind mentioned at the outset that is easy to operate and allows for spontaneous communication with a component of a welding installation.

### SUMMARY OF THE INVENTION

In accordance with the invention, this object is accomplished in a method of the kind mentioned at the outset in that the data and/or programs are embedded in a URI or in a MIME format and are transmitted in a standard format of NFC data transmission via the NFC communication channel between a mobile terminal device and the component of the welding installation, wherein the data and/or programs transmitted from the mobile terminal device are extracted by and directly processed by the component of the welding installation without establishing a connection to a web-based resource and without necessarily presenting the URI data content or MIME data content.

The invention incorporates the idea that many mobile terminal devices, in particular smartphones, tablet computers and personal digital assistants (PDAs), come as standard with an NFC interface which permits near field communication. The mobile terminal device thus equipped has, as standard, a software program for near field communication, wherein standard functions of the mobile terminal device's operating system and pre-installed applications provided as standard by the manufacturer of the mobile terminal device, such as file browsers, Internet browsers, e-mail programs and/or display and play functions for image data, video data or audio data, are used. The NFC data transmission provided for by the manufacturers of such mobile terminal devices is realized in a standard format and permits for example cashless payment of small amounts at the checkout in a supermarket. In accordance with the invention, it has been found that the standard function of the mobile terminal device for near field communication can also be used for transmitting data and programs which, with respect to the standard function of the mobile terminal device, are per se foreign thereto, namely typical of the welding installation, provided that the data and/or programs are embedded in a URI or in a MIME format, because when thus embedded, these foreign data and/or programs, too, can be readily transmitted from the mobile terminal device using a standard format of NFC data transmission. The abbreviation “MIME” stands for “Multipurpose Internet Mail Extension”, and the abbreviation “URI” stands for “Uniform Resource Identifier”. A uniform resource identifier is used to identify a resource on the Internet, which may be for example a web page or other file or may also be an e-mail recipient. By embedding the data and/or programs in a URI or in a MIME format, the data and/or programs can be transmitted between the mobile terminal device and the component of the welding installation without the use of a software program that is designed specifically to communicate with a component of a welding installation. Mobile terminal devices having near field communication capability are very widely used and are therefore ordinarily available to the user of the welding installation. By embedding the required data and/or programs, for example for a functional extension of a welding installation, in a URI or in a MIME format and transmitting the data and/or programs thus embedded in a standard format of NFC data transmission, the user of the welding installation will be able to perform a functional extension thereof spontaneously, without having to first acquire an NFC card well in advance or having to install special software on his or her mobile terminal device.

The data and/or programs transmitted from the mobile terminal device to the component of the welding installation are extracted by and directly processed by the component of the welding installation, without the component of the welding installation establishing a connection to a web-based resource. Hence, the component of the welding installation can be configured such that it is unable to establish a connection to a web-based resource at all. It is also not necessary for the component of the welding installation to display the URI data content or MIME data content. Therefore, the component of the welding installation which communicates with the mobile terminal device via the NFC communication channel need not necessarily be configured such that it has the capability of presenting the URI or MIME data content. Rather, it is only necessary for the component of the welding installation to use the data and/or programs for processing, for example for extending the functions of the welding installation. In particular, provision may be made for the data and/or programs to be used for updating an existing welding program or also for extending a welding program.

Advantageously, the data transmitted between the mobile terminal device and the component of the welding installation comprise textual information, setting values, in particular setting values specific to the welding task, configuration data, parameters, language settings, Flash files and/or information for service and help desk purposes.

Advantageously, the programs transmitted between the mobile terminal device and the component of the welding installation comprise executable program codes and/or programs.

For example, the component of the welding installation uses the transferred data and/or programs for controlling actuators that exercise influence over an electrical, physical or chemical process. Also, measurement value capturing systems can be influenced by way of the data and/or programs, wherein electrical, physical or chemical quantities are captured and/or processed by way of the measurement value capturing systems. The electrical or physical process is preferably an electric arc welding process.

The standard format of NFC data transmission which is used to transfer the data and/or programs embedded in a URI or in a MIME format is preferably an NDEF data format. The abbreviation “NDEF” stands for “NFC Data Exchange Format”, which is a data format specified by the NFC Forum. The NFC Forum is formed of different companies, in particular companies operating in the field of information technology, and pursues the implementation and standardization of NFC technology. NDEF data formats are known to the person skilled in the art and are widely used, and the use of an NDEF data format provides a particularly simple way of wirelessly transmitting the data and/or programs with the aid of a commercially available mobile terminal device that is capable of near field communication. Use of an NDEF data format makes it possible for the embedded data and/or programs to be transmitted according to the standardized application-level protocol. In particular, the transmission can be realized according to the SNEP (Simple NDEF Exchange) Protocol. Corresponding standard functions of the mobile terminal device are often called “Share” or “Beam”. They are used in order, for example, to transfer web links from a first mobile terminal device, in particular a first smartphone, to a second terminal device, in particular a second smartphone, via an NFC communication channel. This transmission scheme is distinguished by using a particularly simple and intuitive procedure. It allows even users without technical knowledge and training to transmit the desired data and/or programs.

In particular, an NFC data format of the type “well known type” or “media type” may be used as the NDEF data format.

The transfer of the data and/or programs from the mobile terminal device may be realized in such a way that only such functions of the mobile terminal device are used as are installed thereon as standard, in particular functions of the operating system, the web browser, the e-mail program and/or general display and play functions for MIME data.

In an advantageous embodiment of the method in accordance with the invention, a particularly simple way of transmitting the data and/or programs is achieved by the data and/or programs being embedded in a web link and the web link being called up in a web browser or in an e-mail program of the mobile terminal device. By way of its web browser, the mobile terminal device can establish an Internet connection to, for example, a web server, wherein the data and/or programs are embedded in the web link required therefor.

For example, provision may be made for an Internet connection to be established from the mobile terminal device to a web-based resource and for information, in particular instructions for action to be taken, pertaining to the data and/or programs embedded in the web link, to be downloaded from the web-based resource and for this information to be graphically or audibly indicated on the mobile terminal device. The mobile terminal device comes as standard with a display and/or indicating device which frequently takes the form of a touch-sensitive screen (touchscreen). On the display device, the user can have graphically displayed to him or her instructions pertaining to the establishment of the desired near field communication with the component of the welding installation. It may also be provided for the information to be audibly indicated to the user via a loud speaker of the mobile terminal device. For example, the user may receive information prompting him or her to position the mobile terminal device at an NFC interface of the component of the welding installation. The mobile terminal device then establishes an NFC communication channel with the help of the mobile terminal device's standard software, and the data and/or programs embedded in the web link are automatically transferred to the component of the welding installation in a standard format of NFC data transmission.

In an advantageous embodiment of the invention, the data and/or programs are stored and/or processed by the web-based resource. For example, provision may be made for the data and/or programs to be prepared by the web-based resource in such a way that they can be visualized on a display device of the mobile terminal device.

In an advantageous embodiment of the method in accordance with the invention, the data and/or programs are embedded in a photo file, an audio file or a video file, said file being graphically or audibly indicated on the mobile terminal device.

In an advantageous configuration of the invention, the data and/or programs are embedded in a URI or in a MIME format by way of a web-based resource. The web-based resource may be run for example by the manufacturer of the welding installation or a company authorized by the manufacturer of the welding installation.

Preferably, a web server is used as the web-based resource.

Advantageously, the data and/or programs embedded in a URI or in a MIME format are transmitted from the web-based resource to the mobile terminal device by e-mail or via an Internet connection. It is thus possible for the user to request the desired data and/or programs from the web-based resource, for example from a web server. The web-based resource embeds the desired data and/or programs in a URI or in a MIME format, and the data and/or programs thus embedded are transferred from the web-based resource to the mobile terminal device by e-mail or via an Internet connection. In addition, further information, in particular instructions for action to be taken and/or additional information, pertaining to the data and/or programs, can be transmitted from the web-based resource to the mobile terminal device by e-mail or via the Internet connection and can be displayed by the mobile terminal device on the display device thereof. It may also be provided for information pertaining to the data and/or programs to be made available to the mobile terminal device in the form of an audio or video file and to be played by the mobile terminal device.

Data and/or programs embedded in a URI or in a MIME format may be transmitted from the mobile terminal device to the component of the welding installation. Alternatively or in addition, provision may be made for data and/or programs embedded in a URI or in a MIME format to be transmitted from the component of the welding installation to the mobile terminal device.

Advantageously, the data and/or programs transmitted from the mobile terminal device and embedded in a URI or in a MIME format are extracted by the component of the welding installation by way of an extraction unit. As has already been mentioned, it is not necessary for the component of the welding installation to have the capability of presenting the URI or MIME data content. Once extracted, the data and/or programs transmitted to the component of the welding installation via the NFC interface thereof can be processed; for example, they can be used for extending the functions of the welding installation.

Advantageously, data to be transmitted to the mobile terminal device are embedded in a URI or in a MIME format by way of an embedding unit of the component of the welding installation.

Advantageously, the NFC data transmission between the mobile terminal device and the component of the welding installation is realized bidirectionally. This not only allows data and/or programs to be transmitted from the mobile terminal device to the component of the welding installation, but it also affords the possibility of data and/or programs being transferred from the component of the welding installation to the mobile terminal device via the NFC communication channel, wherein with this transmission route as well, the data and/or programs are embedded in a URI or in a MIME format and are transferred in a standard format of NFC data transmission.

By way of example, provision may be made for the component of the welding installation, once it has received data and/or programs from the mobile terminal device via the NFC communication channel, to request an enabling or authorization code from the mobile terminal device via the NFC communication channel. The request can be realized in such a way that the component of the welding installation embeds request data in, for example, a URI and transfers this via the NFC communication channel to the mobile terminal device. Since the data are transferred in a standard format of NFC data transmission, the data can be processed using the standard method provided by the operating system of the mobile terminal device. In the present case, the operating system of the mobile terminal device proposes to open the web browser and inquire the enabling or authorization code from the web-based resource defined in the URI. This inquiry includes the request data embedded in the URI by the embedding unit of the component of the welding installation. Thus, the request data are automatically transmitted to the web-based resource without the mobile terminal device having to perform any action that deviates from the standard. Upon receipt of the request data, which may for example include an identification number of the welding installation, the web-based resource can perform an authorization check. If the check indicates that the component of the welding installation from which the request for the enabling or authorization code originates is authorized to process the data and/or programs, then the web-based resource can embed the enabling or authorization code in a URI or in a MIME format and transmit it via the Internet to the mobile terminal device. From the mobile terminal device, the embedded enabling or authorization code can be transferred in a standard format of NFC data transmission via the NFC communication channel to the component of the welding installation. Upon receipt of the enabling or authorization code, the component of the welding installation can process the data and/or programs by, for example, performing an extension of functions desired by the user.

Advantageously, NFC communication with the component of the welding installation is realized in Peer-to-Peer Mode or in Card Emulation Mode. These modes are per se known to the person skilled in the art and need not be discussed in more detail here.

Advantageously, the connection establishment and the data transfer between the mobile terminal device and the component of the welding installation is according to NFC Forum's “Connection Handover Technical Specification”. This is a specification proposed by the NFC Forum which describes how the connection can be established and how the data can be transmitted.

In an advantageous embodiment of the method in accordance with the invention, a Bluetooth or WLAN connection is automatically established between the component of the welding installation and the mobile terminal device upon receipt of the data and/or programs, in particular when data are transmitted in the MIME format. Thus, in such a configuration, the transfer of the data and/or programs via the NFC communication channel serves to establish a Bluetooth or WLAN connection for further transfer of data and/or programs.

As has already been mentioned, the component of the welding installation to which data and/or programs are transmitted from the mobile terminal device or from which data and/or programs are transmitted to the mobile terminal device, may be a control component, a power supply component, a power component, an operator control component, a welding torch, a wire feeding component, a water cooling component or also, for example, a network component of the welding installation.

The invention further relates to a component of an electric welding installation for carrying out the method described above. In accordance with the invention, the component of the electric welding installation comprises an NFC interface for wireless near field communication with a mobile terminal device. The component further comprises an extraction unit and/or an embedding unit, wherein data and/or programs embedded in a URI or in a MIME format are capable of being extracted by way of the extraction unit and wherein data and/or programs are capable of being embedded in a URI or in a MIME format by way of the embedding unit. Furthermore, the component of the welding installation constructed in accordance with the invention comprises a processing unit for direct processing of the extracted data and/or programs without establishing a connection to a web-based resource and without necessarily presenting the URI data content or the MIME data content.

As has already been mentioned, the data and/or programs embedded in a URI or in a MIME format can be transmitted from the mobile terminal device via the NFC communication channel in a standard format of NFC data transmission without the use of an application software program specially adapted to the welding installation. To this end, the component of the welding installation comprises an NFC interface, and the data and/or programs embedded in a URI or in a MIME format can be extracted by the component of the welding installation by way of an extraction unit and can be directly processed by the component of the welding installation by way of a processing unit. The data are extracted and processed without the component of the welding installation establishing a connection to a web-based resource. Furthermore, the component of the welding installation needs not necessarily provide an indication of the extracted data and/or programs. For example, the data and/or programs can be used for extending the functions of the component of the welding installation without the component of the welding installation even having the capability of providing a graphical or an audible indication of the URI data content or MIME data content or of establishing a connection to a web-based resource. In order to transfer data and/or programs from the component of the welding installation to the mobile terminal device, the component of the welding installation comprises an embedding unit with the aid of which data and/or programs can be embedded in a URI or in a MIME format.

The data capable of being transmitted preferably comprise textual information, setting values, in particular setting values specific to the welding task, configuration data, parameters, language settings, Flash files and/or information for service and help desk purposes.

Preferably, the data and/or programs are capable of being used for controlling actuators that exercise influence over an electrical, physical or chemical process.

It is advantageous if measurement value capturing systems are capable of being influenced by way of the data and/or programs, wherein electrical, physical or chemical quantities are capable of being captured and/or processed by way of the measurement value capturing systems.

Preferably, data and/or programs embedded in a URI or in a MIME format are capable of being transmitted in an NDEF data format by way of the NFC interface of the component of the welding installation. Transmission in an NDEF data format is advantageous in that connection establishment and data transmission between the mobile terminal device and the component of the welding installation can be realized in accordance with the NFC Forum's Connection Handover Technical Specification, i.e. by way of a specification that is widely used in information technology.

In an advantageous configuration of the component of the electric welding installation constructed in accordance with the invention, data and/or programs embedded in a URI or in a MIME format are capable of being transmitted bidirectionally between the component of the electric welding installation and the mobile terminal device. It is thus possible for data and/or programs that are embedded in a URI or in a MIME format to be transferred both from the mobile terminal device to the component of the welding installation and from the component of the electric welding installation to the mobile terminal device, wherein the transfer is realized in a standard format of NFC data transmission.

Advantageously, the data and/or programs embedded in a URI or in a MIME format are capable of being transferred in Peer-to-Peer Mode or in Card Emulation Mode.

It is particularly advantageous for the component of the electric welding installation to comprise a Bluetooth or WLAN interface and for a Bluetooth or WLAN connection to the mobile terminal device to be automatically established from the component of the welding installation upon receipt of data and/or programs embedded in a URI or in a MIME format. Such a configuration is advantageous in that it provides a way of first transmitting data and/or programs via the NFC communication channel from the mobile terminal device to the component of the electric welding installation and subsequently automatically establishing a Bluetooth or WLAN connection from the component of the electric welding installation to the mobile terminal device.

Advantageously, the component of the electric welding installation is a control component, a power supply component, a power component, an operator control component, a welding torch, a wire feeding component, a water cooling component or, also, a network component of the welding installation.

The following description of an advantageous embodiment of the invention, taken in conjunction with the drawing, serves to explain the invention in greater detail.

### BRIEF DESCRIPTION OF THE DRAWING

FIG. 1: shows a block diagram of an electric welding installation in accordance with an example embodiment of the present invention

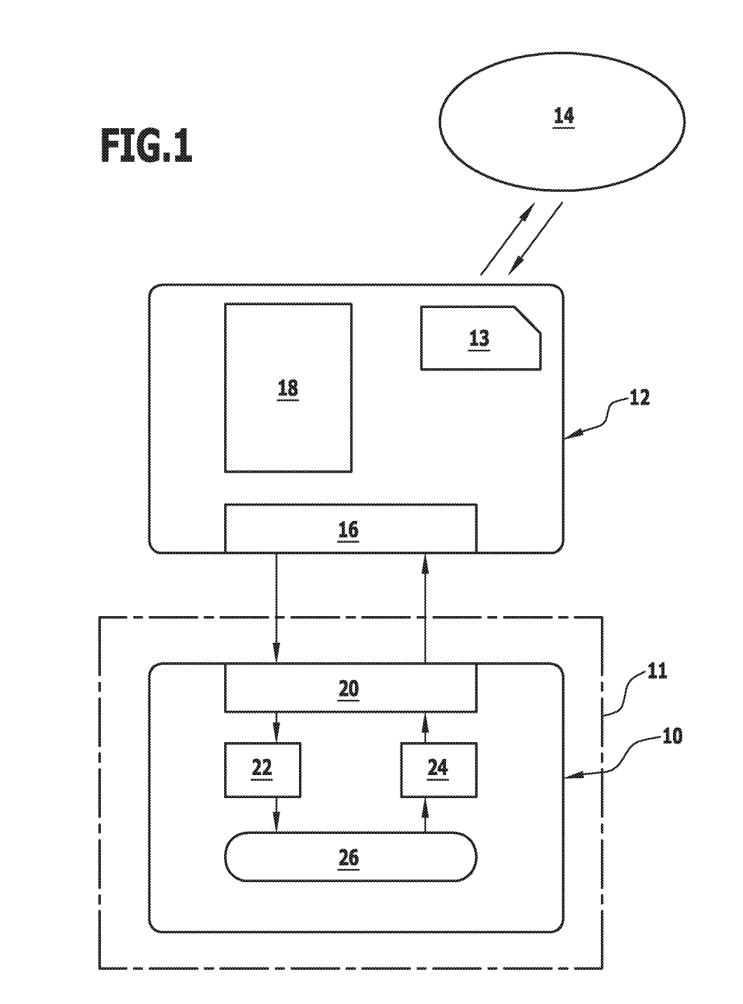

### DETAILED DESCRIPTION

Shown in the single figure of drawing are a component, generally designated by the reference numeral 10, of an electric welding installation 11 as well as a mobile terminal device 12 and a web-based resource 14. The component 10 of the welding installation 11 may be for example a control component, a power supply component, a power component, an operator control component, a welding torch, a wire feeding component, a water cooling component or may also be a network component of an electric welding installation.

The mobile terminal device 12 may be configured in the form of, for example, a smartphone; it may also be configured in the form of a tablet computer or a personal digital assistant (PDA), for example. It may also be provided for the mobile terminal device 12 to be configured in the form of a notebook.

The web-based resource 14 may be configured for example in the form of a web server that is provided by the manufacturer of the welding installation component 10 or by a company authorized by the manufacturer of the welding installation component 10 and to which a connection can be established from the mobile terminal device 12 via the Internet. To this end, the mobile terminal device comprises a web browser 13 which can be used to call up a web link, in particular a URI address.

The mobile terminal device 12 has an NFC interface 16 and a display and/or indicating device 18 which may be, for example, a touchscreen. The mobile terminal device 12 is equipped with a customary operating system and also with an e-mail program. Furthermore, the mobile terminal device 12 includes customary display and play functions and a standard software program for NFC communication. The NFC communication is realized via the NFC interface 16.

The component 10 of the welding installation 11 has an NFC interface 20 which is configured to interact with the NFC interface 16 of the mobile terminal device 12 for establishing an NFC communication channel, wherein communication is realized in a standard format of NFC data transmission. Furthermore, the component 10 comprises an extraction unit 22 and an embedding unit 24. By way of the extraction unit 22, data and/or programs which are received by the component 10 via the NFC interface 20 and are embedded in a URI or in a MIME format can be extracted; and by way of the embedding unit 24, data and/or programs can be embedded by the component 10 in a URI or in a MIME format in order for the embedded data to be subsequently transmitted wirelessly via the NFC interface 20 to the NFC interface 16 of the mobile terminal device 12.

Furthermore, the component 10 comprises a processing unit 26 which uses the transmitted data and/or programs. The processing unit 26 may comprise for example a storage member and a microprocessor which is used for controlling an actuator of the welding installation and/or which is connected in signal-conducting relationship with a measurement value capturing system of the welding installation.

A user of the welding installation 11 can transfer data and/or programs from the mobile terminal device 12 to the welding installation component 10. Such a transfer can be realized in order, for example, to extend the functions of the welding installation 11. In the exemplary embodiment as illustrated, the user can, in a first step, by way of the web browser 13 of the mobile terminal device 12, establish an Internet connection to the web-based resource 14 and request corresponding data and/or programs therefrom. The data and/or programs are provided by the web-based resource 14, wherein the web-based resource 14 embeds the data and/or programs in a URI or in a MIME format. The data and/or programs thus embedded are transmitted from the web-based resource 14 to the mobile terminal device 12 either via the Internet or by e-mail. In the exemplary embodiment as illustrated, the data and/or programs are embedded in a web link which can subsequently be called up by the web browser 13 of the mobile terminal device 12. A connection is then established via the Internet to a certain web page of the web-based resource 14 from which the user can download information, in particular instructions for action to be taken, pertaining to the data and/or programs requested. This information can be graphically indicated to the user on the display device 18. The information includes a prompt requesting the user to position the mobile terminal device 12 at the NFC interface 20 of the component 10 of the welding installation 11 at as short a distance as possible therefrom. Thereafter, an NFC communication channel is automatically established between the NFC interface 16 of the mobile terminal device 12 and the NFC interface 20 of the component 10, and the data and/or programs embedded in a URI or in a MIME format are automatically transmitted in a standard format of NFC data transmission from the mobile terminal device 12 to the component 10. Data transmission is realized using software with which the mobile terminal device 12 is equipped as standard, without requiring the use of a special application software program which the user of the mobile terminal device 12 would have to install thereon in addition to creating the NFC communication channel with the component 10. The special application software can be omitted because the data and/or programs are embedded in a URI or in a MIME format and are transmitted in a standard format of NFC data transmission, wherein this standard format is also used for establishing an NFC communication channel with another mobile terminal device. Advantageously, connection establishment and data transmission is realized according to the Connection Handover Technical Specification of the NFC Forum, wherein an NDEF data format is used as the standard format.

The component 10 extracts the embedded data and/or programs by way of the extraction unit 22 and then forwards them to the processing unit 26. The processing unit 26 processes the data and/or programs to achieve the functional extension desired by the user.

The NFC communication channel between the mobile terminal device 12 and the component 10 is of bidirectional configuration, meaning that data and/or programs can also be transferred from the component 10 to the mobile terminal device 12. To this end, the component 10 comprises the embedding unit 24 with which data and/or programs provided by the processing unit 26 are embedded in a URI or in a MIME format. The data and/or programs thus embedded are transferred in a standard format of NFC data transmission from the NFC interface 20 of the component 10 to the NFC interface 16 of the mobile terminal device 12, provided that the mobile terminal device 12 is positioned at the NFC interface 20 of the welding installation component 10 at very short distance therefrom.

Advantageously, the embedding unit 24 embeds the data and/or programs that are to be transmitted to the mobile terminal device 12 in a web link which subsequently, once the data and/or programs have been received by the mobile terminal device 12, can be called up by the web browser 13 of the mobile terminal device 12 in order to establish an Internet connection to the web-based resource 14. The web-based resource 14 can evaluate the data and/or programs transmitted from the component 10 via the mobile terminal device 12. By way of example, the data and/or programs can contain a request to the web-based resource 14 to transmit an enabling or authorization code that is required for processing the data and/or programs that have previously been transmitted from the mobile terminal device to the component 10. The web-based resource 14 can then perform an authorization check. If the web-based resource 14 approves the authorization, it will transmit to the mobile terminal device 12 a corresponding enabling or authorization code which is embedded in a URI or in a MIME format and which can be transferred from the mobile terminal device 12 to the component 10 in the same manner as has been previously described. Once the enabling or authorization code is received by the component 10, the processing unit 26 can perform the desired functional extension.

A user can thus perform a functional extension of the component 10 at any time, provided that he or she can establish a connection to the web-based resource 14 by way of the mobile terminal device 12. Functional extension is possible without the mobility of the electric welding installation being affected thereby or without the electric welding installation having to be permanently networked.

1. Method for near field communication with a component of an electric welding installation, wherein data and/or programs are transmitted via an NFC communication channel, wherein the data and/or programs are embedded in a URI or in a MIME format and are transmitted in a standard format of NFC data transmission via the NFC communication channel between a mobile terminal device and the component of the welding installation, wherein the data and/or programs transmitted from the mobile terminal device are extracted by and directly processed by the component of the welding installation without establishing a connection to a web-based resource and without necessarily presenting the URI data content or MIME data content.

2. Method in accordance with claim 1, wherein the data comprise textual information, setting values, in particular setting values specific to the welding task, configuration data, parameters, language settings, Flash files and/or information for service and help desk purposes.

3. Method in accordance with claim 1, wherein the data and/or programs are used for controlling actuators that exercise influence over an electrical, physical or chemical process.

4. Method in accordance with claim 1, wherein measurement value capturing systems are influenced by way of the data and/or programs, wherein electrical, physical or chemical quantities are captured and/or processed by way of the measurement value capturing systems.

5. Method in accordance with claim 1, wherein the standard format of NFC data transmission is an NDEF data format.

6. Method in accordance with claim 1, wherein for the transfer of the data and/or programs from the mobile terminal device, only such functions are used as are installed thereon as standard.

7. Method in accordance with claim 1, wherein the data and/or programs are embedded in a web link and in that the web link is called up in a web browser or in an e-mail program of the mobile terminal device.

8. Method in accordance with claim 7, wherein an Internet connection is established from the mobile terminal device to a web-based resource and information, in particular instructions for action to be taken, pertaining to the data and/or programs, is downloaded from the web-based resource and is graphically and/or audibly indicated on the mobile terminal device.

9. Method in accordance with claim 8, wherein the data and/or programs are stored and/or processed by the web-based resource.

10. Method in accordance with claim 1, wherein the data and/or programs are embedded in a photo file, an audio file or a video file and wherein said file is graphically or audibly indicated on the mobile terminal device.

11. Method in accordance with claim 1, wherein the data and/or programs are embedded in a URI or in a MIME format by way of a web-based resource.

12. Method in accordance with claim 11, wherein the web-based resource is a web server.

13. Method in accordance with claim 11, wherein the embedded data and/or programs are transmitted from the web-based resource to the mobile terminal device via an e-mail connection or Internet connection.

14. Method in accordance with claim 1, wherein the data and/or programs transmitted from the mobile terminal device and embedded in a URI or in a MIME format are extracted by way of an extraction unit of the component of the welding installation.

15. Method in accordance with claim 1, wherein the data and/or programs to be transmitted to the mobile terminal device are embedded in a URI or in a MIME format by way of an embedding unit of the component of the welding installation.

16. Method in accordance with claim 1, wherein the transmission of data and/or programs between the mobile terminal device and the component of the welding installation is realized bidirectionally.

17. Method in accordance with claim 1, wherein the connection establishment and the data transfer is performed according to NFC Forum's Connection Handover Technical Specification.

18. Method in accordance with claim 1, wherein a Bluetooth or WLAN connection is automatically established between the component of the welding installation and the mobile terminal device upon receipt of the data and/or programs.

19. Method in accordance with claim 1, wherein the component of the welding installation is a control component, a power supply component, a power component, an operator control component, a welding torch, a wire feeding component, a water cooling component or a network component of the welding installation

20. Component of an electric welding installation for carrying out the method in accordance with claim 1, wherein the component comprises an NFC interface for wireless near field communication with a mobile terminal device and wherein the component comprises an extraction unit and/or an embedding unit, wherein data and/or programs embedded in a URI or in a MIME format are extractable by way of the extraction unit and wherein data and/or programs are embeddable in a URI or in a MIME format by way of the embedding unit and wherein the component of the welding installation comprises a processing unit for direct processing of the extracted data and/or programs without establishing a connection to a web-based resource and without necessarily presenting the URI data content or the MIME data content.

21. Component of an electric welding installation in accordance with claim 20, wherein data and/or programs embedded in a URI or in a MIME format are transmittable in an NDEF data format by way of the NFC interface.

22. Component of an electric welding installation in accordance with claim 20, wherein data and/or programs that are embedded in a URI or in a MIME format are transmittable both from the mobile terminal device to the component of the welding installation and from the component of the welding installation to the mobile terminal device.

23. Component of an electric welding installation in accordance with claim 20, wherein the component comprises a Bluetooth or WLAN interface and in that a Bluetooth or WLAN connection to the mobile terminal device is automatically establishable from the component upon receipt and extraction of the data and/or programs embedded in a URI or in a MIME format.

24. Component of an electric welding installation in accordance with claim 20, wherein the component is a control component, a power supply component, a power component, an operator control component, a welding torch, a wire feeding component, a water cooling component or a network component of the welding installation.
